(19) United States
(12) Patent Application Publication
(10) Pub. No.: US 2015/0326072 A1
(43) Pub. Date: Nov. 12, 2015

(54) Boost-Charger-Boost System for Enhanced Power Delivery

(71) Applicant: Energous Corporation, Pleasanton, CA (US)

(72) Inventors: Jason Petras, Brentwood, CA (US); Michael Leabman, San Ramon, CA (US)

(21) Appl. No.: 14/272,280

(22) Filed: May 7, 2014

(51) Int. Cl. H02J 17/00; H02J 7/02

(52) U.S. Cl. CPC H02J 17/00; H02J 7/025

(57) ABSTRACT

A controlled-power delivery system may operate with RF waves for supplying continuous and suitable power to a load. The controlled-power delivery system may include one or more receiving antennas, one or more rectifiers, a first boost converter, a charger, a storage element, and a second boost converter. The first boost converter may step up the rectified DC voltage obtained from the receiving antenna and rectifier to supply a suitable voltage level that can be used for charging the storage element. The second boost converter may increase the voltage from the storage element to a suitable level that may satisfy the power requirements of the load. The charger in conjunction with the first and second boost converters may be configured to allow a plurality of modes of operation for delivering power to the load and charging the storage element.

### CROSS-REFERENCE TO RELATED APPLICATIONS

The present disclosure is related to U.S. non-provisional patent application DWV-3DPF-010 entitled “Methodology for Pocket-forming”; DWV-3DPF-015 DWV-3DPF-027 entitled “Receivers for Wireless Power Transmission”; and DWV-3DPF-029 entitled “Transmitters for Wireless Power Transmission” invented by Michael Leabman; in addition to ENG-SYHW-001 entitled “Enhanced Receiver for Wireless Power Transmission” invented by Jason Petras and Michael Leabman, each of which are incorporated by reference in their entirety herein.

### BACKGROUND

1. Field of the Disclosure

The present disclosure relates in general to wireless power transmission, and more specifically, to circuit configurations for obtaining and delivering power from radio frequency (RF) waves.

2. Background Information

Battery-powered systems for delivering continuous and controlled power or voltage to a load may integrate the functions of one buck converter and one boost converter into a single system, automatically switching from buck or boost operation based on the state of the storage element. However, these systems may not properly work with low voltage, variable power sources, and they may be limited in terms of the number of available modes of operation.

What is needed is a power delivery system capable of working with low voltage, variable power sources (e.g. RF waves), while providing the flexibility of different modes of operation.

### SUMMARY

A controlled-power delivery system disclosed herein may be capable of using RF waves to deliver continuous and controlled power to a load. In one embodiment, the controlled-power delivery system may include one or more receiving antennas, one or more rectifiers operatively coupled with the receiving antennas, a first boost converter, a charger, an storage element, a second boost converter, and a load. The receiving antenna may convert transmitted RF waves into AC voltage or power that may be converted into DC voltage or power by the rectifier. The first boost converter may step up the DC voltage from the rectifier to a DC voltage level that may be used by the charger for charging the storage element, where this storage element may include a battery or a capacitor. The second boost converter may increase the voltage from the storage element to deliver a suitable voltage level to the load, where this load may include the battery or internal circuitry of an electronic device.

According to embodiments described herein, the controlled-power delivery system may sustain a plurality of operation modes.

In one embodiment, the controlled-power delivery system may exhibit a current conduction path where the power delivered to the load can be obtained only from the storage element.

In another embodiment, the controlled-power delivery system may exhibit a current conduction path where the power delivered to the load can be obtained only from transmitted RF waves.

Yet in another embodiment, the controlled-power delivery system may exhibit a current conduction path where the power extracted from RF waves can be delivered to the load and the storage element simultaneously.

In a further embodiment, the controlled-power delivery system may exhibit a current conduction path where the power extracted from RF waves can be delivered only to the storage element.

In an even further embodiment, the controlled-power delivery system may exhibit a current conduction path where the power delivered to the load can be obtained simultaneously from RF waves and the storage element.

The controlled-power delivery system disclosed herein may be employed in receivers for wireless power transmission, where RF waves may be used for the generation of a suitable and continuous voltage that can be applied to a load. In addition, the controlled-power delivery system may be able to work with low voltage power sources and may be able to support a plurality of modes of operation for improved functionality. Additional features and advantages can become apparent from the detailed descriptions which follow, taken in conjunction with the accompanying drawings.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a typical battery-powered system according to some aspects of the prior art;

FIG. 2 shows a controlled-power delivery system for extracting power from RF waves and delivering continuous power to a load, according to an embodiment;

FIG. 3 depicts a first operation mode that may be implemented in the controlled-power delivery system of FIG. 2, where the power delivered to the load may be directly obtained from a storage element;

FIG. 4 shows a second operation mode that may be implemented in the controlled-power delivery system of FIG. 2, where the power delivered to the load can be directly obtained from transmitted RF waves;

FIG. 5 shows a third operation mode that may be implemented in the controlled-power delivery system of FIG. 2, where power extracted from RF waves can be used for simultaneously powering the load and charging the storage element;

FIG. 6 illustrates a fourth operation mode that may be implemented in the controlled-power delivery system of FIG. 2, where the power extracted from RF waves can be used for only charging the storage element; and

FIG. 7 illustrates a fifth operation mode that may be implemented in the controlled-power delivery system of FIG. 2, where the power delivered to the load may obtained from RF waves and the storage element simultaneously.

### DETAILED DESCRIPTION

The present disclosure is here described in detail with reference to embodiments illustrated in the drawings, which form a part here. Other embodiments may be used and/or other changes may be made without departing from the spirit or scope of the present disclosure. The illustrative embodiments described in the detailed description are not meant to be limiting of the subject matter presented here.

### DEFINITIONS

As used here, the following terms may have the following definitions:

“Pocket-forming” may refer to generating two or more RF waves which converge in 3-d space, forming controlled constructive and destructive interference patterns.

“Pockets of energy” may refer to areas or regions of space where energy or power may accumulate in the form of constructive interference patterns of RF waves.

“Null-space” may refer to areas or regions of space where pockets of energy do not form because of destructive interference patterns of RF waves.

“Transmitter” may refer to a device, including a chip which may generate two or more RF signals, at least one RF signal being phase shifted and gain adjusted with respect to other RF signals, substantially all of which pass through one or more RF antenna such that focused RF signals are directed to a target.

“Receiver” may refer to a device which may include at least one antenna, at least one rectifying circuit, at least one input boost converter, at least one storage element, at least one output boost converter, at least one switch, and at least one communication subsystem for powering or charging an electronic device using RF waves.

“Buck” may refer to a DC-to-DC power electronic converter which may have its output voltage lower than its input voltage.

“Boost” may refer to a DC-to-DC power electronic converter which may have its output voltage higher than its input voltage.

### DESCRIPTION OF THE DRAWINGS

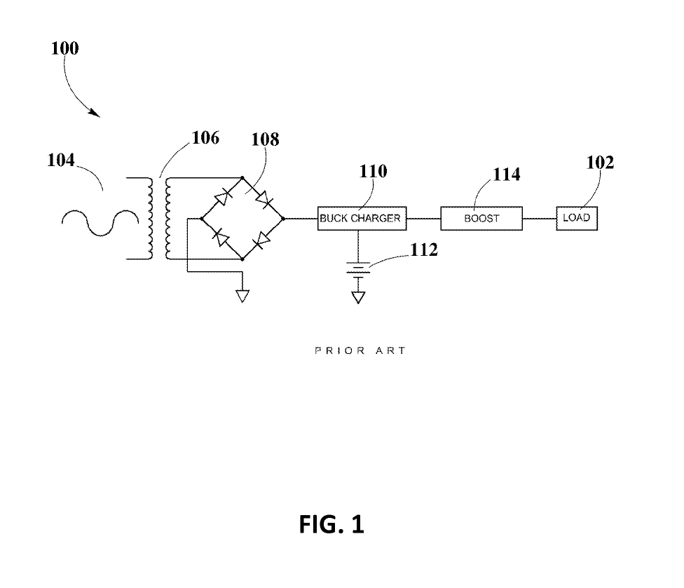

FIG. 1 illustrates a typical battery-powered system 100 according to some aspects of the prior art. Battery-powered system 100 may be used for delivering continuous direct current (DC) power or voltage to a load 102, where this load 102 may include the battery or internal circuitry of an electronic device such a smartphone, a laptop computer, a tablets, a PDAs, and a desktop computer, and the like.

In battery-powered system 100, an alternating current (AC) power source 104 may be connected to a transformer 106 which may reduce the AC voltage from power source 104 to a particular AC voltage level depending on the turns ratio of the primary and secondary coils of transformer 106. For example, AC voltage from power source 104 may be reduced from about 120 volts down to about 16 volts.

The reduced AC voltage coming out of transformer 106 may be converted to direct current (DC) voltage by a rectifier 108 which may include 4 diodes for full-wave rectification. That is, the output of rectifier 108 may be about 16 volts DC. Rectifier 108 may exhibit conduction losses due to the voltage drops across the diodes.

The rectified DC voltage can now be applied to a buck charger 110 which may function as a DC-to-DC power converter to drive down the DC voltage to a level that can be used for charging a storage element 112. For example, the 16 volts DC at the output of rectifier 108 may be reduced to about 5 volts DC that may be used for charging storage element 112. Storage element 112 may include a battery or a capacitor. For example, a battery with a voltage level of about 3 to about 4.2 volts can be used for storage element 112.

To make full use of the energy of the storage element 112, a boost converter 114 may be used provide the necessary voltage for load 102. That is, boost converter 114 may step up the voltage from storage element 112 to deliver a suitable voltage level to load 102. As a way of example, boost converter 114 may constantly deliver about 5 volts DC to load 102.

Although some fundamentals of battery-powered system 100 may be used for delivering continuous controlled power to load 102, battery-powered system 100 may be not efficiently operate with variable power sources obtained from RF waves, which may also imply working within low voltage levels.

Wireless power transmission may include the use of RF waves for extracting power that may be used for charging or powering an electronic device. According to some aspects of wireless power transmission, a transmitter may send a beam of RF waves towards a receiver, where these RF waves may generate a 3-D pocket of energy that may be used by the receiver apparatus for charging or powering an electronic device. One challenge that may be present during wireless power transmission is that power or energy extracted from RF waves may be variable due to inherent characteristics of the medium. That is, the environment of transmission may be affected by changes to or movement of objects within the physical boundaries, or movement of the boundaries themselves. It may be also affected by changes to the medium of transmission; for example, changes to air temperature or humidity. Moreover, the power that can be extracted from RF waves may be zero at some instances of the wireless power transmission.

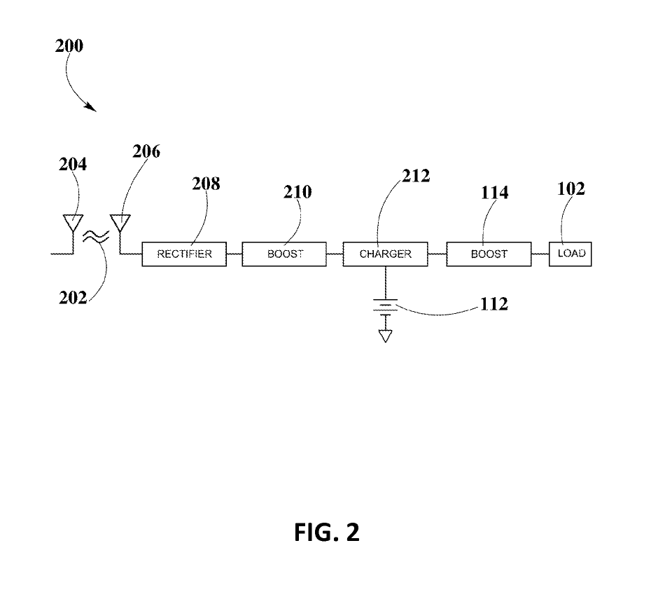

FIG. 2 shows a controlled-power delivery system 200 for extracting power from a variable power source and delivering continuous voltage at suitable levels to load 102. According to some aspects of this embodiment, a variable power source may be in the form of RF waves 202 conveyed from one or more transmitting antennas 204, where these RF waves 202 may be collected by one or more receiving antennas 206. In one embodiment, transmitting antenna 204 may be part of a transmitter (not shown in FIG. 2) capable of directing RF waves 202 towards a receiver (not shown in FIG. 2) for charging or powering an electronic device. Controlled-power delivery system 200 may be part of a receiver suitably configured for wireless power transmission.

Receiving antenna 206 may convert the electromagnetic energy from RF waves 202 into AC voltage. Consequently, a rectifier 208, operatively coupled with receiving antenna 206, may convert this AC voltage into DC voltage. In one embodiment, rectifier 208 may operate in synchronous mode, in which case rectifier 208 may include switching elements that may reduce losses, thereby improving the efficiency of rectification. As an illustrative embodiment, and not by way of limitation, output of rectifier 208 may vary from about 0 volts to about 5 volts DC.

A first boost converter 210 may convert the variable DC output voltage of rectifier 208 into a more stable DC voltage that may be used by a charger 212 for charging storage element 112. First boost converter 210 may operate as a step-up DC-to-DC converter to increase the voltage from rectifier 208 to a voltage level suitable for proper operation of charger 212. As an illustrative embodiment, and not by way of limitation, first boost converter 210 may operate with low input voltages of at least 0.4 volts to about 5 volts DC to produce an output voltage between about 4.2 volts and about 5.5 volts DC. In addition, first boost converter 210 may reduce or eliminate rail-to-rail deviations. In one embodiment, first boost converter 210 may exhibit a synchronous topology to increase power conversion efficiency. In another embodiment, first boost converter 210 may use a maximum power point tracking (MPPT) algorithm run by microcontroller (not shown in FIG. 2) to control and maximize the amount of power that first boost converter 210 can pull from RF waves 202.

Charger 212 may include suitable components for controlling the power delivered to storage element 112 and load 102. Charger 212 may include a low dropout (LDO) circuit and/or a synchronous DC-to-DC conversion circuit to charge storage element 112 based on a charging algorithm. Storage element 112 may include a battery, a capacitor, and the like. The charging algorithm used in charger 212 may depend on the chemistry and operational specifics of storage element 112. For example, a lithium-ion battery may require a constant current/constant voltage (CC/CV) algorithm to properly charge. In addition, charger 212 may include circuitry that may allow power to take multiple paths throughout the controlled-power delivery system 200. For example, from input to output; from input to storage element 112; from storage element 112 to output; from input to output and from storage element 112 to output; and from input to storage element 112 and output.

Similarly as in FIG. 1, controlled-power delivery system 200 may include second boost converter 114 to match impedance and power requirements of load 102. Second boost converter 114 may also include a synchronous topology to increase power conversion efficiency.

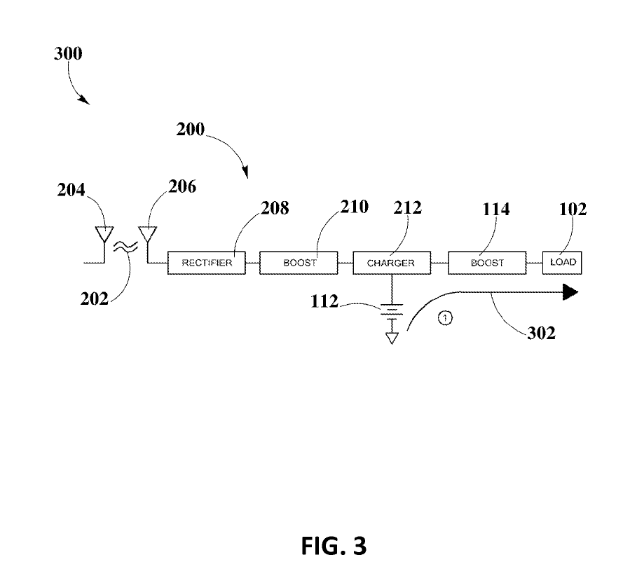

FIG. 3 illustrates an operation mode 300 that may be implemented in controlled-power delivery system 200 according to an embodiment. Operation mode 300 may exhibit a current conduction path 302 where the power delivered to load 102 can be directly obtained from storage element 112, passing through second boost converter 114.

In one embodiment, current conduction path 302 may be employed when there are power requirements at load 102, but there is either none or not enough power available from in first boost converter 210. Consequently, voltage can be drained from storage element 112, as long as it is not below its set minimum. As previously explained, second boost converter 114 may step up the voltage drained from storage element 112 to suitable levels that can be used by load 102.

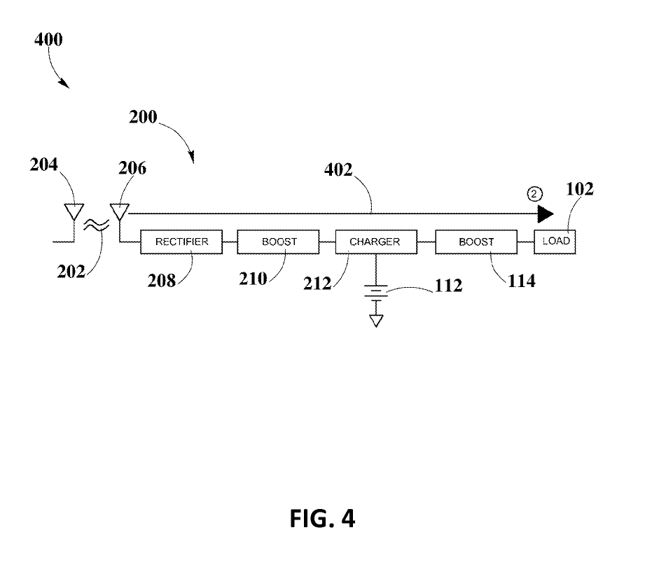

FIG. 4 depicts an operation mode 400 that may be implemented in controlled-power delivery system 200 according to an embodiment. Operation mode 400 may exhibit a current conduction path 402 where the power delivered to load 102 can be directly obtained from transmitted RF waves 202.

According to some aspects of this embodiment, current conduction path 402 may be originated when transmitted RF waves 202 may be converted into AC voltage by receiving antenna 206, where this AC voltage can be converted into DC voltage by rectifier 208. First boost converter 210 and second boost converter 114 may step up the rectified voltage to suitable levels that may be used by charger 212 and load 102. In this case, charger 212 may determine that the power or voltage extracted from RF waves 202 is suitable for powering load 102, and/or that storage element 112 may not require charging. In another embodiment, charger 212 may determine that the power or voltage that can be extracted from RF waves 202 is only sufficient for powering load 102.

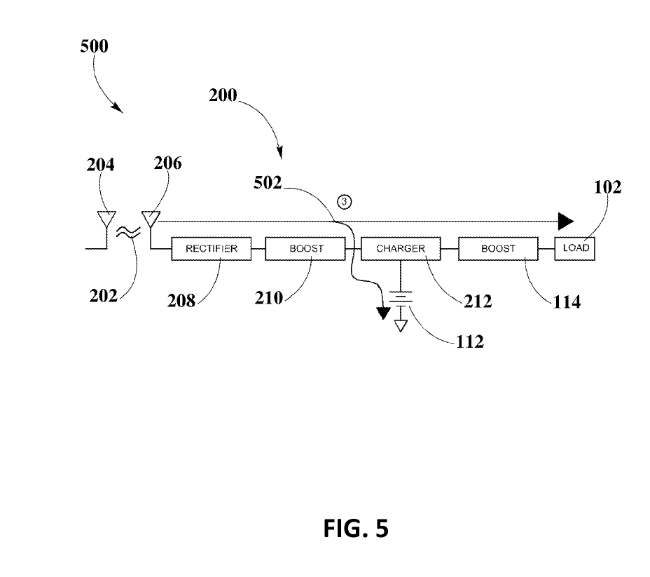

FIG. 5 shows an operation mode 500 that may be implemented in controlled-power delivery system 200 according to an embodiment. Operation mode 500 may exhibit a current conduction path 502 where power extracted from RF waves 202 can be delivered to load 102 and storage element 112 simultaneously.

According to some aspects of this embodiment, when powering load 102, if there is an excess of power available from rectifier 208 and first boost converter 210, then this excess of power may be used to charge storage element 112. In this way, current conduction path 502 may allow suitable powering of load 102 and charging of storage element 112.

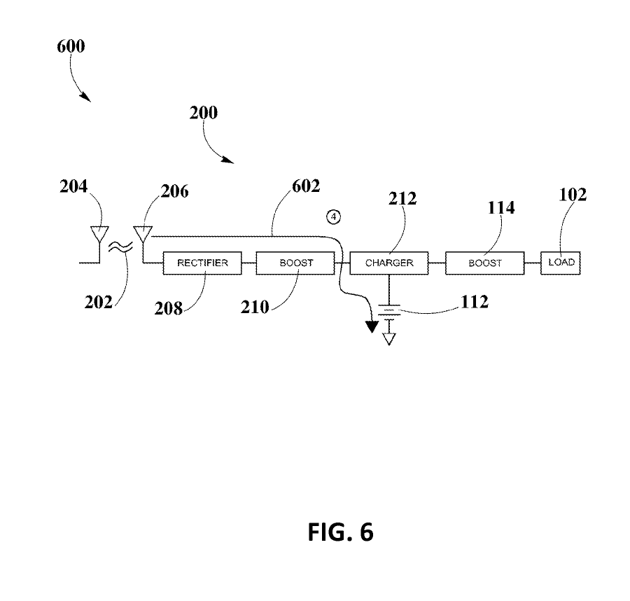

FIG. 6 shows an operation mode 600 that may be implemented in controlled-power delivery system 200. According to some aspects of this embodiment, if load 102 does not require powering, then a current conduction path 602 may be used, where power extracted from RF waves 202 through receiving antenna 206, rectifier 208 and first boost converter 210 can be delivered only to storage element 112.

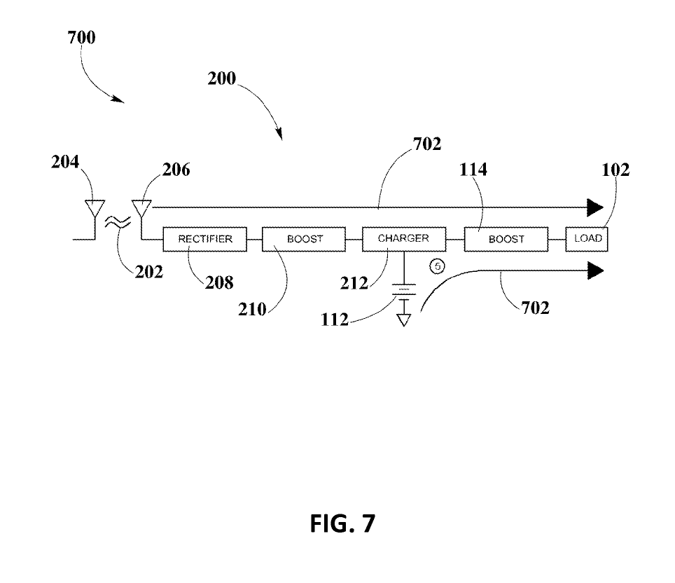

FIG. 7 shows an operation mode 700 that may be implemented in controlled-power delivery system 200. According to some aspects of this embodiment, a current conduction path 702 may be operable in controlled-power delivery system 200 when charger 212 may be turned off for allowing current flow from storage element 112 to load 102. Simultaneously, power can also be applied from receiving antenna 206, rectifier 208, first boost converter 210 and second boost converter 114 to load 102. Current conduction path 702 may be applicable when the power or voltage that can be extracted from RF waves 202 or storage element 112 may not be sufficient for suitability powering load 102, in which case it may be required to extract power from both, RF waves 202 and storage element 112, at the same time.

The preceding description of the disclosed embodiments is provided to enable any person skilled in the art to make or use the present invention. Various modifications to these embodiments may be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A receiver for providing power, comprising:
an antenna configured to convert electromagnetic energy from radio-frequency (RF) waves into AC voltage;
a rectifier, operatively couple to the antenna for converting the AC voltage into DC voltage;
a first boost converter, operatively coupled to the rectifier, the first boost converter being configured to increase the voltage output from the rectifier;
a charger, configured to receive an output from the first boost converter;
a storage element, configured to receive an output from the charger; and
a second boost converter, operatively coupled to the charger, the second boost converter being configured to match impedance and power requirements for a load,
wherein the receiver is configured to function under a plurality of operational modes for providing a conduction path, wherein the conduction path comprises one of:
(i) power from the storage element to the load, passed through the second boost converter,
(ii) power from first boost converter to the load, passed through the second boost converter,
(iii) power provided to the storage element via the charger,
(iv) power simultaneously provided via a combination of (i) and (ii)
(v) power simultaneously provided via a combination of (ii) and (iii)

2. The receiver of claim 1, wherein the antenna is configured to convert electromagnetic energy from 3-D pockets of energy in the RF waves.

3. The receiver of claim 1, wherein the storage element comprises one of a battery and a capacitor.

4. The receiver of claim 1, wherein operational mode (v) is selected by the receiver when the receiver determines that excess power for the load is available from the first boost converter.

5. The receiver of claim 1, wherein operational mode (iv) is selected by the receiver when the receiver determines that insufficient power for the load is available from the first boost converter.

6. The receiver of claim 1, wherein the first boost converter is configured with a synchronous topology to increase power conversion efficiency.

7. The receiver of claim 1, wherein the first boost converter comprises a microcontroller for executing a maximum power point tracking (MPPT) process for maximizing the amount of power that the first boost converter can pull from the RF waves.

8. A method of providing power in a receiver, comprising:
converting electromagnetic energy from radio-frequency (RF) waves into AC voltage via an antenna;
converting the AC voltage into DC voltage;
increasing the voltage output from the rectifier via a first boost converter;
providing the increased voltage to a charger for charging a storage element;
matching impedance and power requirements for a load via a second boost converter,
configuring the receiver to function under a plurality of operational modes for providing a conduction path, wherein the conduction path comprises one of:
(i) power from the storage element to the load, passed through the second boost converter,
(ii) power from first boost converter to the load, passed through the second boost converter,
(iii) power provided to the storage element via the charger,
(iv) power simultaneously provided via a combination of (i) and (ii)
(v) power simultaneously provided via a combination of (ii) and (iii)

9. The method of claim 8, wherein the step of converting electromagnetic energy in the antenna comprises converting electromagnetic energy from 3-D pockets of energy in the RF waves.

10. The method of claim 8, wherein the storage element comprises one of a battery and a capacitor.

11. The method of claim 8, wherein operational mode (v) is selected by the receiver when the receiver determines that excess power for the load is available from the first boost converter.

12. The method of claim 8, wherein operational mode (iv) is selected by the receiver when the receiver determines that insufficient power for the load is available from the first boost converter.

13. The method of claim 8, wherein the step of increasing the voltage output from the rectifier via a first boost converter comprises a synchronous topology to increase power conversion efficiency.

14. The method of claim 8, further comprising the step of executing a maximum power point tracking (MPPT) process in a first boost converter microcontroller for maximizing the amount of power that the first boost converter can pull from the RF waves.

15. A receiver for providing power to a load, the receiver comprising an antenna configured to convert electromagnetic energy from radio-frequency (RF) waves into AC voltage and a rectifier, operatively couple to the antenna for converting the AC voltage into DC voltage, the receiver further comprising:
a first boost converter configured to increase the voltage output from the rectifier and provide the increased voltage to a charger operatively coupled to a storage element comprising one of a battery and a capacitor;
a second boost converter, operatively coupled to the charger, the second boost converter being configured to match impedance and power requirements for the load,
wherein the receiver is configured to function under a plurality of operational modes for providing a conduction path, wherein the conduction path comprises one of:
(i) power from the storage element to the load, passed through the second boost converter,
(ii) power from first boost converter to the load, passed through the second boost converter,
(iii) power provided to the storage element via the charger,
(iv) power simultaneously provided via a combination of (i) and (ii)
(v) power simultaneously provided via a combination of (ii) and (iii)

16. The receiver of claim 15, wherein the antenna is configured to convert electromagnetic energy from 3-D pockets of energy in the RF waves.

17. The receiver of claim 15, wherein operational mode (v) is selected by the receiver when the receiver determines that excess power for the load is available from the first boost converter.

18. The receiver of claim 15, wherein operational mode (iv) is selected by the receiver when the receiver determines that insufficient power for the load is available from the first boost converter.

19. The receiver of claim 15, wherein the first boost converter is configured with a synchronous topology to increase power conversion efficiency.

20. The receiver of claim 15, wherein the first boost converter comprises a microcontroller for executing a maximum power point tracking (MPPT) process for maximizing the amount of power that the first boost converter can pull from the RF waves.
